(19) United States
(12) Patent Application Publication
(10) Pub. No.: US 2025/0023104 A1
(43) Pub. Date: Jan. 16, 2025

(54) NON-AQUEOUS ELECTROLYTE COMPOSITIONS

(71) Applicant: FARADION LIMITED, Sheffield South Yorkshire (GB)

(72) Inventors: Christopher WRIGHT, Sheffield South Yorkshire (GB); Ashish RUDOLA, Sheffield South Yorkshire (GB); Ruth SAYERS, Sheffield South Yorkshire (GB); Anthony RENNIE, Sheffield South Yorkshire (GB)

(21) Appl. No.: 18/708,032

(22) PCT Filed: Nov. 8, 2022
(86) PCT No.: PCT/GB2022/052823

§ 371 Date: May 7, 2024

(30) Foreign Application Priority Data
Nov. 8, 2021 (GB) 2116036.1
Aug. 23, 2022 (GB) 2212271.7

(51) Int. Cl. H01M 10/0569; H01M 10/054; H01M 10/0567; H01M 10/0568; H01M 10/42

(52) U.S. Cl. CPC H01M 10/0569; H01M 10/054; H01M 10/0567; H01M 10/0568; H01M 10/4235; H01M 2300/0037; H01M 2300/004

(57) ABSTRACT

The invention relates to a non-aqueous electrolyte composition having a solvent system which comprises a first component which comprises a first organo carbonate-based solvent and a second organo carbonate-based solvent; and a second component which comprises one or more performance additives that includes tris(trimethylsilyl) borate (TMSB). Devices, methods and uses including electrolytes compositions are also disclosed.

### FIELD OF THE INVENTION

The present invention relates to novel non-aqueous electrolytes compositions, a sodium-ion cell comprising said novel non-aqueous electrolyte compositions and energy storage devices such as batteries, rechargeable batteries, electrochemical devices, and electrochromic devices which include said non-aqueous electrolyte compositions. Methods and uses including said novel electrolytes compositions are also disclosed.

### BACKGROUND OF THE INVENTION

Sodium-ion batteries are analogous in many ways to the lithium-ion batteries that are in common use today; they are both reusable secondary batteries that comprise an anode (negative electrode), a cathode (positive electrode) and an electrolyte material, both are capable of storing energy, and they both charge and discharge via a similar reaction mechanism. When a sodium-ion (or lithium-ion) battery is charging, Na⁺ (or Li⁺) ions deintercalate from the cathode and insert into the anode. Meanwhile charge balancing electrons pass from the cathode through the external circuit containing the charger and into the anode of the battery. During discharge the same process occurs but in the opposite direction.

One area that needs more attention is the development of suitable electrolyte compositions, particularly for use in sodium-ion cells.

Although the design of suitable electrolyte compositions is given less attention than active materials (electrodes), their importance should not be overlooked as they are in large part the key to battery life and for determining the practical performance achievable by a cell, for example in terms of capacity, rate capability, safety etc. However, to be a suitable electrolyte composition, it must fulfil a long list of attributes, these include:
Chemical stability—there must be no reactions during the cell operation, including within the electrolyte itself or with the separator, the electrodes, current collectors or the packaging materials used;
Electrochemical stability—there must be a wide electrochemical stability window i.e., a large separation between the high and low onset potentials for decomposition by oxidation or reduction;
Thermal stability—the electrolyte composition must not decompose or chemically break down during normal cell operation and operational temperature;
Physical properties—the electrolyte composition needs to be liquid therefore its melting and boiling points must be well outside the internal operating temperatures of the cell;
High ionic and low electronic conductivities are necessary to maintain cell operation by Na⁺ transport and to minimize self-discharge of the cell, respectively;
Low toxicity;
Based on sustainable chemistries, i.e. made using abundant elements and via low impact syntheses (energy, pollution etc.) and
Cost effective production.

In lithium-ion cells, the most common electrolyte compositions contain either LiPF₆ or LiBF₄ dissolved in organic carbonate-based solvents; electrolyte compositions comprising 1M LiPF₆ in either a mixture of EC (ethylene carbonate)/DMC (dimethyl carbonate) or a mixture of EC (ethylene carbonate)/EMC (ethyl methyl carbonate) are regarded by most workers as the “standard” Li-ion cell electrolytes.

In the case of sodium-ion cells, the sodium analogue, NaPF₆, may be used in place of the LiPF₆, but a much more cost-effective alternative is NaBF₄; the latter also has the benefit of improved thermal stability compared with NaPF₆. Unfortunately, however, NaBF₄ has very low solubility in organic carbonate-based electrolyte solvents, and this results in the ionic conductivity of the resulting electrolyte compositions being generally too low for practical application. Thus, poor solubility of NaBF₄-containing electrolyte compositions in traditional organic carbonate-based solvents produce inferior electrochemical performance when compared against an equivalent cell using NaPF₆.

Furthermore, it should also be stated that although some materials used in lithium systems are able to be carried over to their sodium counterpart, it is by no means safe to assume that this will always be the case, due, in part, to the larger atomic radius of sodium compared to that of lithium. Thus, solvent systems that work for lithium-ion batteries might not work for sodium-ion batteries and vice-versa. A prominent example of this difference is the incompatibility of propylene carbonate (PC) solvent in lithium-ion batteries with graphite anode (the most commonly used anode in commercial lithium-ion systems currently). Due to this incompatibility, commercial lithium-ion batteries typically use EC/DMC or EC/EMC solvent system, as mentioned previously. By contrast, sodium-ion systems will happily tolerate an electrolyte solvent that includes PC.

It is clearly desirable to find electrolyte compositions which are optimal for promoting high sodium-ion battery performance. One such strategy for promoting high sodium-ion battery performance is to dope the solvent system of the electrolyte composition with a performance additive in order to promote or even impart one or more desired properties of an electrolyte composition. However, a sodium-ion cell relies on how the electrolyte composition interacts with the components of the sodium-ion cell (e.g., the separator, positive and negative electrodes etc). This interaction is based on a mosaic of physical properties of the electrolyte composition, which cannot be predicted. In particular, as set out above, it is necessary for the electrolyte composition to have high ionic and low electronic conductivities to maintain cell operation by Na+ transport. However, such high ionic and low electronic conductivities must also be balanced at the very least with the ability to maintain chemical and electrochemical stability so that the sodium-ion cell can charged and discharged over many cycles.

Due to differences between lithium and sodium-ion chemistries because of the larger atomic radius of sodium compared to that of lithium as discussed above, and because of the use of different electrode active materials (graphite and hard carbon negative electrode used in lithium-ion cells and sodium-ion cells respectively), efficient additives for use in lithium-ion cells are not necessarily efficient for use sodium-ion cells as is made quite clear in Hijazi et al., Batteries & Supercaps, 2021, 4, 1-17.

Further still, most of the existing studies carried out on additives for use in an electrolyte composition containing one or more sodium-containing salts are carried out in sodium-metal half cells, and not in sodium-ion full cells where issues from the positive electrode can be observed. For example, Chen et al., Chem. Commun., 2015, 51, 9809-9812 investigated sodium-difluoro (oxalato) borate (NaDFOB) as an additive in one or more organo carbonate-based solvents, but experimental data was generated using sodium-metal half cells. Drawing a parallel between sodium-metal half cells and sodium-ion full cells can be misleading due to several factors as mentioned below:

Firstly, sodium-metal half cells typically do not operate under the same voltage conditions as sodium-ion full cells.

In sodium-metal half-cells, the experimenter pairs the electrode material they wish to study (called ‘working electrode’ or WE), with a Na metal counter electrode (CE), which serves as the anode (and reference electrode), along with the electrolyte they wish to assess. The WE can operate at either low potentials vs Na (such as operating between 0 V-2 V vs Na/Na+), or high potentials vs Na (such as operating between 2.5 V-4.5 V vs Na/Na+). If it is the former, then the WE will become the anode when used in ‘full cells’ (that is, the traditionally understood Na-ion cells), whilst the latter will cause the WE to become the cathode in full cells.

For example, if the experimenter is studying a low potential WE in half-cells (such as operating between 0 V-2 V vs Na/Na+), then the performance of the WE and electrolyte combination is only being assessed at these low potentials and not at high potentials (i.e., between 2.5 V-4.5 V vs Na/Na+). For an electrolyte composition, this is very relevant, because in sodium-ion full cells, the electrolyte composition will be experiencing not only low potentials (which it was experiencing in the aforementioned half-cell experiment), but also high potentials (which the electrolyte composition will be experiencing in full cells when paired with a high potential cathode). Thus, even if an electrolyte composition can show great performance for a low potential WE in sodium half-cells, the experimenter will not know whether that electrolyte composition can be utilised in a Na-ion ‘full cell’ when paired with a traditional cathode.

This issue is well-known in the battery literature. For example, refer to Ponrouch et al., Energy Environ. Sci, 2012, 5, 8572-8583, which illustrates how the electrochemical stability window of different salt-solvent combinations changes when used in sodium-ion batteries: in particular, it is clear from their FIG. 8a that ‘NaTFSI-PC’ electrolyte composition can be used as an electrolyte composition between 0-3.5 V vs Na/Na+, but unsuitable for testing above 3.5 V vs Na/Na+. Thus, this particular electrolyte composition will only be suitable for testing anodes in half-cells—it will be unsuitable for testing full Na-ion cells where the cathode will operate at potentials >3.5 V vs Na/Na+.

Secondly, errors in analyses of sodium-metal half cells are not the same as the errors in analyses of sodium-ion full cells.

The PhD thesis titled “ENERGY STORAGE USING SODIUM-ION BATTERIES” by Ashish Rudola published in 2015 highlights two artefacts that the Na metal counter electrode (which is the anode used in half-cells) can cause, when studying the performance of the WE. In sodium-metal half-cells, the cycling profile of the WE can have artefacts during its cycling, such as ‘voltage steps’ which occur because of the enhanced polarisation of the Na metal counter electrode (and this voltage step does not arise due to the WE which the experimenter is assessing). Furthermore, the high polarisation of the Na metal counter electrode leads to a lower high-rate performance of the WE which the experimenter is trying to assess—this obviously leads to errors in analyses.

Thirdly, electrolyte compositions tested in sodium-metal half cells may not decompose in the same way as electrolyte compositions tested in sodium-ion full cells.

As explained in Chapter 6 in the book titled ‘Na-ion Batteries’ (Monconduit, L., Croguennec, L. (eds) (2020). Na-ion Batteries. ISTE Ltd, London and Wiley, New York), surface species can spontaneously form on Na metal electrode due to electrolyte decomposition when in contact with the highly reactive Na metal. As noted therein, this issue is more pronounced for Na half-cells than Li half-cells (“high reactivity of sodium metal compared to lithium metal negative electrodes in contact with the aprotic carbonate-based electrolyte commonly used in batteries”). Obviously, if the surface of the Na metal counter electrode is covered by surface species which will only arise in half-cells and not full cells (as there will be no Na metal in the full cell), then this surface layer would affect the results and conclusions from the half-cell experiment which might not be translatable to full cells.

Therefore, at least due to the factors mentioned above, conclusions from studies carried out on electrolyte compositions tested in sodium-metal half cells will not be directly translatable to full cells.

WO 2020/240209 A1 relates to non-aqueous electrolyte compositions having a first solvent component comprising one or more organo carbonate-based solvents; and a second component comprising one or more surfactants in an amount of >0.5 to ≤10% by weight of the solvent system. With regard to additive applications, WO 2020/240209 A1 undoubtably relates to the use of a surfactant as an additive. Although it mentions the use of tris(trimethylsilyl) borate (TMSB) in experiment 17, there is, however, no indication in WO 2020/240209 A1 that TMSB can be used in two or more carbonate-based solvents.

A PhD thesis titled “STUDIES OF ANODES AND THEIR INTERACTIONS WITH ELECTROLYTES IN SODIUM-ION BATTERIES” by Du Kang relates to anode materials and their interactions with electrolytes in sodium-ion batteries. With regard to additive applications, this thesis mentions the use of TMSB in sodium-metal half cells, but not in sodium-ion full cells. Further still, TMSB was only used in 1M NaBF₄ in tetraglyme, and thus there is no indication in this PhD thesis that TMSB can be used in two or more carbonate-based solvents.

In summary, neither WO 2020/240209 A1 nor the PhD thesis by Du Kang teach or suggest the use of TMSB as a performance additive in two or more carbonate-based solvents in an electrolyte composition for a sodium-ion full cell. Furthermore, none of these documents provide any indication that such an electrolyte composition would have the mosaic of physical properties that are necessary for promoting high sodium-ion full cell performance.

The aim of the present invention therefore is to provide improved sodium ion conducting electrolyte compositions (that is, they are electrolyte compositions which are designed for use in sodium-ion secondary cells) which use sodium-containing salts in a solvent system comprising two or more carbonate-based solvents. The electrolyte compositions of the present invention will be especially useful in sodium-ion cells which employ an anode electrode which comprises a non-graphitic carbon-containing material such as a hard carbon-containing material, or an anode which comprises a sodium insertion material, or a conversion and/or alloying anode material. The electrolyte compositions of the present invention will demonstrate excellent electrochemical performance in sodium-ion cells, and most preferably in sodium-ion full cells.

### SUMMARY OF THE INVENTION

The present invention achieves these aims by providing: a non-aqueous electrolyte composition comprising:
a) one or more sodium-containing salts; and
b) a solvent system which comprises:
   i. a first component which comprises a first organo carbonate-based solvent and a second organo carbonate-based solvent, optionally in which the second organo carbonate-based solvent is different from the first organo carbonate-based solvent; and
   ii. a second component which comprises one or more performance additives that includes tris(trimethylsilyl) borate (TMSB) in an amount of >0 to ≤10% by weight of the solvent system.

Advantageously, TMSB used in the second solvent component of solvent system enables the formation of a stable cathode-electrolyte interphase (CEI) on the cathode and/or a stable solid-electrolyte interphase (SEI) on the anode, which in turn leads to advantages such as enhanced long-term cycling stability and improved discharge capacity retention and/or energy retention. This effect is particularly surprising in a solvent system comprising two or more carbonate-based solvents.

The amount of TMSB used in the second component of the solvent system according to the present invention, is typically >0.5 to ≤10% by weight of the solvent system, preferably ≥0.6 to ≤6% by weight of the solvent system, further preferably ≥0.6 to ≤4% by weight, very preferably ≥0.6 to ≤3% by weight and ideally 0.6 to ≤2.5% by weight, based on the weight of the solvent system.

The amount of TMSB used in the second component of the electrolyte composition of the present invention, may be >0 wt % weight of the solvent system, preferably >0.2 wt % weight of the solvent system, and highly preferably ≥0.5 wt %, based on the weight of the solvent system.

For the avoidance of any doubt, the phase “weight of the solvent system” as used herein means the total weight of the solvent system (i.e. excluding the weight(s) of the one or more sodium containing salts).

The second component of the solvent system may comprise or consist essentially of two or more performance additives. The two or more performance additives may be present as a second component of the solvent system in an amount of >0 to ≤10% by weight of the solvent system. The two or more performance additives may include tris(trimethylsilyl) borate (TMSB) in an amount of >0 to ≤10% by weight of the solvent system, and surfactants or sulfur-containing compounds.

Preferably, the two or more performance additives as a second component of the solvent system may comprise a mixture of TMSB and surfactants. That is, TMSB may be mixed with one or more surfactants to provide a mixture of two or more performance additives. The addition of surfactants to the electrolyte composition of the present invention may further enhance the electrolyte performance due to an unexpected synergistic effect between TMSB and one or more surfactants in a solvent system comprising two or more carbonate-based solvents.

The two or more performance additives as a second component of the solvent system may comprise a mixture of TMSB in an amount of >0 to ≤10% by weight of the solvent system and surfactants in an amount of >0 to ≤10% by weight of the solvent system. Optionally, the total amount of the two or more performance additives as a second component of the solvent system does not exceed about 10% by weight based on the weight of the solvent system.

Preferably, the two or more performance additives as a second component of the solvent system may comprise a mixture of TMSB in an amount of >0 to ≤5% by weight of the solvent system and surfactants in an amount of >0 to 5% by weight of the solvent system. In this embodiment, the total amount of the two or more performance additives as a second component of the solvent system may not exceed about 10% by weight based on the weight of the solvent system.

More preferably, the two or more performance additives as a second component of the solvent system may comprise a mixture of TMSB in an amount of >0 to ≤2.5% by weight of the solvent system and surfactants in an amount of >0 to 2.5% by weight of the solvent system. In this embodiment, the total amount of the two or more performance additives as a second component of the solvent system may not exceed about 5% by weight based on the weight of the solvent system.

One example of two or more performance additives as a second component of the solvent system may comprise a mixture of TMSB in an amount of about 1% by weight of the solvent system and surfactants in an amount of about 1% by weight of the solvent system

Alternatively, the two or more performance additives as a second component of the solvent system may comprise a mixture of TMSB and sulfur-containing compounds. That is, TMSB may be mixed with one or more sulfur-containing compounds to provide a mixture of two or more performance additives. The addition of sulfur-containing compounds to the electrolyte composition of the present invention may further enhance the electrolyte performance due to an unexpected synergistic effect between TMSB and one or more sulfur-containing compounds in a solvent system comprising two or more carbonate-based solvents.

The two or more performance additives as a second component of the solvent system may comprise a mixture of TMSB in an amount of >0 to ≤10% by weight of the solvent system and sulfur-containing compounds in an amount of >0 to ≤10% by weight of the solvent system. Optionally, the total amount of the two or more performance additives as a second component of the solvent system does not exceed about 10% by weight based on the weight of the solvent system.

Preferably, the two or more performance additives as a second component of the solvent system may comprise a mixture of TMSB in an amount of >0 to ≤5% by weight of the solvent system and sulfur-containing compounds in an amount of >0 to ≤5% by weight of the solvent system. In this embodiment, the total amount of the two or more performance additives as a second component of the solvent system may not exceed about 10% by weight based on the weight of the solvent system.

More preferably, the two or more performance additives as a second component of the solvent system may comprise a mixture of TMSB in an amount of >0 to ≤2.5% by weight of the solvent system and sulfur-containing compounds in an amount of >0 to ≤2.5% by weight of the solvent system. In this embodiment, the total amount of the two or more performance additives as a second component of the solvent system may not exceed about 5% by weight based on the weight of the solvent system.

One example of two or more performance additives as a second component of the solvent system may comprise a mixture of TMSB in an amount of about 1% by weight of the solvent system and sulfur-containing compounds in an amount of about 1 or 2% by weight of the solvent system.

The second component of the solvent system may comprise or consist essentially of three or more performance additives. The three or more performance additives may be present as a second component of the solvent system in an amount of >0 to ≤20% by weight of the solvent system. Preferably, the three or more performance additives may be present as a second component of the solvent system in an amount of >0 to ≤10% by weight of the solvent system.

The three or more performance additives as a second component of the solvent system may comprise a mixture of: TMSB; sulfur-containing compounds; and surfactants. The three or more performance additives may include TMSB in an amount of >0 to ≤10% by weight of the solvent system, surfactants, and sulfur-containing compounds. That is, TMSB may be mixed with one or more sulfur-containing compounds and one or more surfactants to provide a mixture of three or more performance additives.

The addition of sulfur-containing compounds and surfactants to the electrolyte composition of the present invention may further enhance the electrolyte performance due to an unexpected synergistic effect between TMSB, one or more sulfur-containing compounds, and surfactants, in a solvent system comprising two or more carbonate-based solvents.

The three or more performance additives as a second component of the solvent system may comprise a mixture of: TMSB an amount of >0 to ≤10% by weight of the solvent system, sulfur-containing compounds in an amount of >0 to ≤10% by weight of the solvent system, and surfactants in an amount of >0 to ≤10% by weight of the solvent system. Optionally, the total amount of the three or more performance additives as a second component of the solvent system does not exceed about 20% by weight based on the weight of the solvent system.

Preferably, the three or more performance additives as a second component of the solvent system may comprise a mixture of: TMSB an amount of >0 to ≤2.5% by weight of the solvent system, sulfur-containing compounds in an amount of >0 to ≤2.5% by weight of the solvent system, and surfactants in an amount of >0 to ≤2.5% by weight of the solvent system.

Highly preferably, the three or more performance additives as a second component of the solvent system may comprise a mixture of: TMSB an amount of >0.5 to ≤2.5% by weight of the solvent system, sulfur-containing compounds in an amount of >0.5 to ≤2.5% by weight of the solvent system, and surfactants in an amount of >0.5 to ≤2.5% by weight of the solvent system. Optionally, the total amount of the three or more performance additives as a second component of the solvent system does not exceed about 5% by weight based on the weight of the solvent system.

Most preferably, the three or more performance additives as a second component of the solvent system may comprise TMSB in an amount of about 1% by weight of the solvent system, sulfur-containing compounds in an amount of about 1 to 2% by weight of the solvent system, and surfactants in an amount of about 1% by weight of the solvent system.

One extremely preferred example of three or more performance additives as a second component of the solvent system may comprise TMSB in an amount of about 1% by weight of the solvent system, sulfur-containing compounds in an amount of about 2% by weight of the solvent system, and surfactants in an amount of about 1% by weight of the solvent system.

Another extremely preferred example of three or more performance additives as a second component of the solvent system may comprise TMSB in an amount of about 1% by weight of the solvent system, sulfur-containing compounds in an amount of about 1% by weight of the solvent system, and surfactants in an amount of about 1% by weight of the solvent system.

The one or more sodium-containing salts of the present invention may be defined as described herein.

The one or more sodium-containing salts (a) preferably comprise one or more weakly coordinating anions. The term “weakly coordinating anion” or “WCA” is well known to those skilled in the art and is used to refer to anions which comprise several (more than one) elements, which may contain halogen atoms and/or oxygen atoms, and which share a single negative charge. This means that the negative charge is spread out over the anion and makes the coordinating ability of the anion comparatively weak, for example relative to the coordinating ability of an anion which has a concentrated negative charge or one with multiple negative charges.

The one or more sodium-containing salts may be selected from one or more compounds of the formula NaMₘXₓ; one or more compounds of the formula NaXO₄; sodium salts of one or more fluoro sulfonyl-containing compounds; sodium salts of one or more fluoro sulfonate-containing compounds; sodium salts of one or more oxalato borate compounds; sodium salts of one or more difluoro-oxalato borate compounds; and one or more compounds that contain a tetrahedral anion such as tetrakis[3,5-bis(trifluoromethyl)phenylborate anion (B[3,5-(CF₃)₂C₆H₃]₄), tris(pentafluorophenyl) borate anion (B(C₆F₅)₄), and tetrakis carboxy (trifluoromethyl)aluminate anion (Al[OC(CF₃)_{3]4}).

Preferably, the one or more sodium-containing salts are selected from: one or more compounds of the formula NaMₘXₓ; wherein M is one or more metals and/or non-metals, and X is a group that comprises or consists of one or more halogens; sodium salts of one or more fluoro sulfonyl-containing compounds; sodium salts of one or more fluoro sulfonate-containing compounds; sodium salts of one or more oxalato borate compounds; and sodium salts of one or more difluoro-oxalato borate compounds.

In the preferred one or more sodium-containing salts of the formula NaMₘXₓ, M is one or more metals and/or non-metals and X is a group that comprises or consists of one or more halogens, preferably selected from fluorine, chlorine, bromine and iodine, further preferably fluorine. The amount x of halogen X is preferably x=1 to 16, further preferably x=4 or 6. The amount, m, of the one or more metals and/or non-metals, M, is preferably m=1 to 3, further preferably m=1 to 2, and particularly preferably m=1. Ideally, the one or more metals and/or non-metals, M, is preferably selected from aluminium, boron, gallium, indium, iridium, platinum, scandium, Yttrium, lanthanum, antimony, arsenic and phosphorus. Particularly preferably, M is selected from aluminium, boron, gallium, phosphorus and arsenic. The most preferred sodium-containing salts of the general formula NaMₙXₓ are one of more selected from sodium tetrafluoroborate (NaBF₄), sodium hexafluorophosphate (NaPF₆).

In the preferred one or more sodium compounds of the formula NaXO₄, the element X is preferably one or more halogens selected from fluorine, chlorine, bromine and iodine. Chlorine is particularly preferred, and the most preferred sodium-containing salt of the formula NaXO₄ is NaClO₄.

Preferred sodium salts of one or more fluoro sulfonyl-containing compounds include sodium bis(fluorosulfonyl)imide also known as NaFSI (Na N(SO₂F)₂) and sodium Bis(trifluoromethanesulfonyl)imide also known as NaTFSI (C₂F₆NNaO₄S₂). Preferred sodium salts of one or more one or more fluoro sulfonate-containing compounds include sodium trifluoromethanesulfonate, also known as sodium triflate or NaOTf (CF₃NaSO₃). Preferred sodium salts of one or more oxalate borate compounds include sodium bis(oxalate), also known as borate NaBOB or NaB(C₂O₄)₂; and sodium-difluoro (oxalato) borate, also known as NaDFOB.

Highly preferably, the one or more sodium-containing salts are selected from sodium hexafluorophosphate (NaPF₆), sodium bis(fluorosulfonyl)imide (NaFSI), and sodium bis(trifluoromethanesulfonyl)imide (NaTFSI). Most preferably, one or more sodium-containing salts include sodium hexafluorophosphate (NaPF₆).

Highly preferably, the electrolyte compositions of the present invention may include two or more sodium-containing salts. The addition of two or more sodium-containing salts to the electrolyte composition of the present invention may further enhance the electrolyte performance due to an unexpected synergistic effect. Advantages such as significantly reduced total charging times may be observed in addition to greater cycling stability and/or higher discharge capacities.

Most preferably, the two or more sodium-containing salts may include a mixture of sodium hexafluorophosphate (NaPF₆) in combination with sodium bis(fluorosulfonyl)imide (NaFSI) and/or sodium bis(trifluoromethanesulfonyl)imide (NaTFSI). Specific examples include a mixture of sodium hexafluorophosphate (NaPF₆) and sodium bis(fluorosulfonyl)imide (NaFSI), or a mixture of sodium hexafluorophosphate (NaPF₆) and sodium bis(trifluoromethanesulfonyl)imide also known as NaTFSI (C₂F₆NNaO₄S₂).

It is convenient to express the amount of the one or more sodium-containing salts in terms of its molality of the components in the solvent system; that is, the total number of moles of the one or more sodium-containing salts (i.e. solute), per kilogram of the solvent system (the combined weight of the first component and the second component)—i.e. mol/kg.

Preferably, the molality of each of the sodium-containing salt individually is in the range 0.1 mol/kg to 5 mol/kg, further preferably 0.3 mol/kg to 5 mol/kg, more preferably in the range 0.1 mol/kg to ≤2.5 mol/kg, and most preferably 0.3 mol/kg to ≤2.5 mol/kg. Highly preferably, particularly when the component is NaPF₆, the molality is in the range 0.1 mol/kg to ≤2.5 mol/kg, ideally 0.3 mol/kg to ≤2.5 mol/kg, and most preferably about 1 mol/kg.

The total molality of all of the sodium-containing salts is preferably in the range 0.1 mol/kg to mol/kg, further preferably 0.3 mol/kg to 10 mol/kg, more preferably in the range 0.3 mol/kg to 6 mol/kg, and most preferably in the range 0.3 mol/kg to ≤4 mol/kg. Highly preferably, 10 when the component is a mixture of NaPF₆ and NaFSI, or alternatively, a mixture of NaPF₆ and NaTFSI, the total molality is in the range 0.1 mol/kg to ≤2.5 mol/kg, ideally 0.3 mol/kg to ≤2.5 mol/kg, and most preferably about 1.5 mol/kg.

The non-aqueous electrolyte compositions of the present invention include a first component which comprises a first organo carbonate-based solvent and a second organo carbonate-based solvent. The second organo carbonate-based solvent is different from the first organo carbonate-based solvent. Typically, the second organo carbonate-based solvent has a different chemical structure from the first organo carbonate-based solvent. Thus, the non-aqueous electrolyte compositions of the present invention include a first component comprising two or more carbonate-based solvents.

The second organo carbonate-based solvent includes one carbonate-based solvent, but as explained below, the second organo carbonate-based solvent may also include one or more further (third) organo carbonate-based solvents. That is, the second organo carbonate-based solvent may be a mixture of organo carbonate-based solvents. Thus, the non-aqueous electrolyte compositions of the present invention may include a first component comprising three or more carbonate-based solvents.

The first and second organo carbonate-based solvents, may be cyclic or non-cyclic compounds that are characterised by the fact that they contain a carbonate ester group, i.e. a carbonyl group that is flanked by one or two alkoxy groups: R₁O(C═O)OR₂. The R₁ and R₂ groups are preferably independently selected (i.e. they may be the same or different from each other) from either hydrogen; or a C₁ to C₂₀-cyclic or non-cyclic, branched or unbranched, substituted or unsubstituted alkyl group; or a C₁ to C₂₀-cyclic or non-cyclic, branched or unbranched, substituted or unsubstituted alkenyl group; or a C₁ to C₂₀-branched or unbranched, substituted or unsubstituted cycloalkyl-, phenyl- or heterocycle-containing group.

Highly suitable first and second carbonate-based solvents include C₃-C₁₀ cycloalkyl organo carbonates, such as propylene carbonate (C₄H₆O₃) and ethylene carbonate (C₃H₄O₃). Propylene carbonate (PC) (C₄H₆O₃) shows particularly favourable compatibility with electrode materials and the high solubility, wide liquidus range and a high boiling point of this material also makes this solvent advantageous for use in metal-ion batteries, particularly sodium-ion batteries. Other highly suitable organo carbonate-based solvents include diethyl carbonate (DEC), dimethyl carbonate (DMC), ethylene carbonate (EC), ethyl methyl carbonate (EMC), fluoroethylene carbonate (FEC) and vinylene carbonate (VC).

Ethylene carbonate (EC), diethyl carbonate (DEC), and propylene carbonate (PC) are preferred as first and second organo carbonate-based solvents. However, it is especially preferred that the first organo carbonate-based solvent comprises propylene carbonate and the second organo carbonate-based solvent is selected from ethylene carbonate (EC) and diethyl carbonate (DEC).

Advantageous electrolyte compositions of the present invention may include propylene carbonate as the first organo carbonate-based solvent in an amount of at least 20%, preferably at least 25% by weight of the solvent system.

In one preferred embodiment, the first component comprises a majority of propylene carbonate (PC). Preferably the first organo carbonate-based solvent comprises propylene carbonate (PC) in amount from >55% to <100% by weight of the solvent system, and the second organo carbonate-based solvent comprises diethyl carbonate (DEC) in amount from >0 to <45% by weight of the solvent system. Ideally in this embodiment, propylene carbonate (PC) is present in amount of about 76% by weight of the solvent system, and diethyl carbonate (DEC) is present in amount of about 20% by weight of the solvent system. Alternatively in this embodiment, propylene carbonate (PC) is present in amount of about 56% by weight of the solvent system, and diethyl carbonate (DEC) is present in amount of about 40% by weight of the solvent system.

In a preferred alternative embodiment, the first organo carbonate-based solvent comprises propylene carbonate (PC), and the second organo carbonate-based solvent comprises a mixture of ethylene carbonate (EC) and diethyl carbonate (DEC). As such, when the first component includes a mixture of ethylene carbonate (EC), diethyl carbonate (DEC) and propylene carbonate (PC), this would ideally be in the weight ratio range 1 to 4:1 to 10:1 to 10 wt/wt and further ideally in the weight ratio 1 to 2:1 to 5:1 to 2 wt/wt, and most preferably in the weight ratio 1:2:1 wt/wt.

As discussed above, the second component of the solvent system according to the present invention may include one or more surfactants. The one or more surfactants of the present invention may be defined as described herein.

The amount of surfactant used in the second component of the solvent system of the present invention, maybe >0.2 to ≤10% by weight of the solvent system, preferably ≥0.2 to ≤4% by weight, very preferably ≥0.5 to ≤3% by weight and ideally 1% to ≤2.5% by weight, based on the weight of the solvent system.

The amount of surfactant used in the second component of the electrolyte composition of the present invention, may be >0 wt % weight of the solvent system, preferably >0.2 wt % weight of the solvent system, and highly preferably ≥0.5 wt %, based on the weight of the solvent system.

The one or more surfactants used in the second component of the solvent system according to the present invention are performance additives and are preferably selected to enhance the ability of the electrolyte composition to wet the separator (particularly a polyolefin separator) and/or the electrode of the battery which, in turn, advantageously promotes a longer battery cycle life.

Preferred one or more surfactant additives are selected from anionic surfactants, cationic surfactants, non-ionic (hydrophilic) surfactants and amphoteric (zwitterionic) surfactants, with anionic surfactants and non-ionic (hydrophilic) surfactants being especially preferred. Such surfactants additives are ideally one or more selected from:
1) anionic (negatively charged) surfactants. Suitable examples include: carboxylates (such as alkyl carboxylates (e.g. fatty acid salts)), carboxylate fluoro-surfactants; sulfates (such as alkyl sulfates (e.g. sodium lauryl sulfate), alkyl ether sulfates (e.g. sodium laureth sulfate)); sulfonates (such as docusates (e.g. dioctyl sodium sulfosuccinate) and alkyl benzene sulfonates); and phosphate esters (such as alkyl aryl ether phosphates and alkyl ether phosphates (e.g. trioctyl phosphate);
2) Zwitterionic (amphoteric) surfactants, which can be anionic, cationic or non-ionic depending on the pH of the solution they are in. Examples include: RN⁺H₂CH₂COO⁻, RN⁺(CH₃)₂CH₂CH₂SO₃⁻, phospholipids (such as phosphatidylcholine (lecithin));
3) Cationic surfactants which bear a positive charge for example RN⁺H₃Cl⁻, RN⁺(CH₃)₃Cl—, didecyldimethylammonium chloride (DDAC), cetyl pyridinium chloride, benzalkonium chloride, hexadecyl trimethylammonium chloride (CTAC) and hexadecyl trimethylammonium bromide (CTAB); and
4) Non-ionic surfactants. These are uncharged, and examples include: polyol esters (e.g. glycol, glycerol esters, sorbitan and sorbitan derivatives such as fatty acid esters of sorbitan (Spans) and their ethoxylated derivatives (Tweens)), polyoxyethylene esters and poloxamers which comprise block copolymers, for example Poloxamer 84, Poloxamer 105, Poloxamer 123, Poloxamer 124, Poloxamer 188, Poloxamer 237, Poloxamer 338, Poloxamer 407 and Poloxamer F127.

Most preferably, the one or more surfactants used in the second component of the solvent system according to the present invention contain one or more non-ionic block copolymer-containing surfactants. Highly suitable examples include poloxamers. A very specific example includes Poloxamer 123 (P123).

As discussed above, the second component of the solvent system according to the present invention may include one or more sulfur-containing compounds. The one or more sulfur-containing compounds of the present invention may be defined as described herein.

The amount of sulfur containing compounds used in the second component of the solvent system of the present invention, maybe >0.2 to ≤10% by weight of the solvent system, preferably ≥0.2 to ≤4% by weight, very preferably ≥0.5 to ≤3% by weight and ideally 1% to ≤2.5% by weight, based on the weight of the solvent system.

The amount of sulfur containing compounds used in the second component of the electrolyte composition of the present invention, may be >0 wt % weight of the solvent system, preferably >0.2 wt % weight of the solvent system, and highly preferably ≥0.5 wt %, based on the weight of the solvent system.

The one or more sulfur-containing compounds used in the second component of the solvent system according to the present invention are performance additives, and are preferably selected to enable the formation of a stable cathode-electrolyte interphase (CEI) on the cathode and/or a stable solid-electrolyte interphase (SEI) on the anode, which in turn leads to advantages such cycle life enhancement.

Suitable sulfur-containing compounds may include cyclic and/or non-cyclic sulfur-containing compounds. Preferably, the sulfur-containing compound is a sulfone-containing compound, a sulfate-containing compound, or a sulfonate-containing compound.

In other words, the sulfur-containing compound may have a sulfonyl functional group which is attached to: two carbon atoms (sulfone), two oxygen atoms (sulfate), or one carbon atom and one oxygen atom in a cyclic or non-cyclic structure (sulfonate). When the sulfonate is cyclic, the compound may be referred to as a sultone.

As used herein the term “sulfone” means that the central hexavalent sulfur atom is doubly-bonded to each of two oxygen atoms and has a single bond to each of two carbon atoms.

As used herein the term “sulfate” means that the central hexavalent sulfur atom is doubly-bonded to two of the oxygen atoms and has a single bond to the other two oxygen atoms, which are each further singly bonded to carbon atoms.

As used herein the term “sulfonate” means that the central hexavalent sulfur atom is doubly-bonded to two of the oxygen atoms; it has a single bond to one carbon atom; and a single bond to the other oxygen atom, which is further singly bonded to a carbon atom, which if cyclically connected to the other carbon atom bonded to the sulfur atom, would be a sultone.

The general formula of such compounds is RY(S═O)₂Y′R′, in which:
Y and Y′ is independently selected from C or O (i.e. they may be the same or different from each other);
when Y and Y′ are the same, R and R′ may be independently selected (i.e. they may be the same or different from each other) from any straight or branched, substituted or unsubstituted C₁ to C₆-alkyl group; a straight or branched, substituted or unsubstituted C₁ to C₆-alkenyl group; a straight or branched, substituted or unsubstituted C₁ to C₆-alkoxy group; or wherein R and R′ may independently or together form a substituted or unsubstituted C₃-C₆-cycloalkyl-, phenyl- or heterocycle-containing group; and
when Y and Y′ are different from each other, R′ may be independently selected from any straight or branched, substituted or unsubstituted C₁ to C₆-alkyl group; a straight or branched, substituted or unsubstituted C₁ to C₆-alkenyl group; a straight or branched, substituted or unsubstituted C₁ to C₆-alkoxy group; or wherein R and R′ may independently or together form a substituted or unsubstituted C₃-C₆-cycloalkyl-, cycloalkenyl-, phenyl- or heterocycle-containing group.

In some embodiments, the general formula of such compounds is R—SO₂—R′, in which R and R′ may be independently selected (i.e. they may be the same or different from each other) from any straight or branched, substituted or unsubstituted C₁ to C₆-alkyl group; a straight or branched, substituted or unsubstituted C₁ to C₆-alkenyl group; a straight or branched, substituted or unsubstituted C₁ to C₆-alkoxy group; or wherein R and R′ may independently or together form a substituted or unsubstituted C₃-C₆-cycloalkyl-, phenyl- or heterocycle-containing group.

Preferably, the general formula of such compounds is RO(S═O)₂OR′, in which R and R′ may be independently selected (i.e. they may be the same or different from each other) from any straight or branched, substituted or unsubstituted C₁ to C₆-alkyl group; a straight or branched, substituted or unsubstituted C₁ to C₆-alkenyl group; a straight or branched, substituted or unsubstituted C₁ to C₆-alkoxy group; or wherein R and R′ may independently or together form a substituted or unsubstituted C₃-C₆-cycloalkyl-, phenyl- or heterocycle-containing group.

Highly preferably, the sulfur-containing compound is selected from a cyclic sulfate (such as 1,3-propanediolcyclic sulfate (PCS) also known as 1,3,2-Dioxathiane 2,2-dioxide (DTD or (CH₂)₃SO₄))); 1,5,2,4-dioxadithiane 2,2,4,4-tetraoxide; or 1,3,2-Dioxathiolane 2,2-dioxide.

Suitable examples of cyclic sulfones include: sulfolane ((CH₂)₄SO₂), 3-methyl sulfolane ((CH₃)CH(CH₂)₃SO₂),), and trimethyl sulfone ((CH₂)₃SO₂). Suitable examples of non-cyclic sulfones include: methyl phenyl sulfone ((CH₃)(C₆H₅)SO₂).

Suitable examples of examples of sultones include: 1-propene 1,3-sultone ((CH)₂CH₂SO₃), and 1,3-propane sultone (CH₂)₃SO₃,

Most preferably, the sulfur-containing compound is 1,3-propanediolcyclic sulfate (PCS).

The electrolyte compositions according to the present invention may further comprise one or more additional compounds which may or may not be a solvent.

Examples of such additional compounds include: a flame retardant compound (such as a polyalkly phosphate-containing compound, preferably a non-fluorinatedpolyalkyl phosphate-containing compound), a diluent (such as a hydrofluoroether-containing compound, preferably a hydrofluoroalkyl ether-containing compound), a glycol ether acetate, an ionic liquid, and any solvent which is capable of promoting the reduction of viscosity of the electrolyte by acting as an inert diluent (such as a hydrofluoroalkyl ether, preferably 1,1,2,2-Tetrafluoroethyl-2,2,3,3-tetrafluoropropyl ether (HFE or TTE)).

The electrolyte compositions according to the present invention may also optionally include one or more further performance additives, typically an amount of <15% by weight, preferably <10% by weight and further preferably 0.1 wt % to <5% by weight, of the total weight of the solvent system used in the electrolyte composition. Such performance additives preferably act at the electrolyte-electrode interface rather than in the bulk of the electrolyte, such as tris(trimethylsilyl)phosphite, or tris(trimethylsilyl)phosphate.

Suitable further performance additives may be selected from: polymerizable additives for promoting overcharge protection such as biphenyl, diphenylamine, dimethoxydiphenylsilane (DDS), 3-chloroanisole (3CA), N-phenylmaleimide, xylene (methyl-substituted benzene) and cyclohexylbenzene; additives for promoting overcharge protection based on redox-shuttle mechanism such as 2,5-di-tert-butyl-1,4 dimethoxybenzene (DDB), 4-tert-butyl-1,2-dimethoxybenzene (TDB), 1,4 bis(trimethylsilyl)-2,5-dimethoxybenzene (BTMSDB) and 1,4-bis(2-methoxyethoxy)-2,5 di-tert-butylbenzene; additives for imparting further flame retardancy attributes to the electrolyte such as dimethyl methylphosphonate (DMMP), ethoxy-pentafluoro-cyclotriphosphazene (N3P3F5OCH2CH3, EFPN), tri (2,2,2-trifluoroethyl)phosphite and/or tri (2,2,2-trifluoroethyl)phosphate (TFEP), methyl nonafluorobuyl ether (MFE) and silane-Al2O3 nanoparticles; additives for promoting better high temperature cycling such as succinic anhydride; and additives for rendering inert unwanted decomposition products (such as HF, water or CO2) in-situ, such as zeolites.

In one embodiment, the electrolyte compositions of the present invention do not include an inert diluent (such as a hydrofluoroalkyl ether, preferably 1,1,2,2-Tetrafluoroethyl-2,2,3,3-tetrafluoropropyl ether (HFE or TTE).

In one embodiment, the electrolyte compositions of the present invention do not include 1,1,2,2-Tetrafluoroethyl-2,2,3,3-tetrafluoropropyl ether (HFE or TTE) in amount of 20% by weight of the solvent system.

The electrolyte compositions of the present invention are especially useful in sodium-ion cells, most preferably sodium-ion full cells (not sodium-metal half cells). Thus, in a further aspect, the present invention provides a sodium-ion cell comprising a negative electrode, a positive electrode and an electrolyte composition as defined herein.

A sodium-ion cell disclosed herein may also include an anode (negative) electrode that includes an anode current collector and/or a cathode (positive) electrode that includes a cathode current collector. The cathode current collector, the anode current collector, or both the cathode current collector and the anode current collector can be formed from aluminium or aluminium alloy (e.g., an alloy of aluminium and one or more of Mg, Mn, Cr, Zn, Si, Fe, and Ni). Preferably, the anode current collector comprises an aluminium current collector. Highly preferably, both the cathode current collector and the anode current collector comprise an aluminium current collector. Alternatively, copper, magnesium, carbon paper/foil/substrate and tin might also be used as current collector materials.

Preferably, the anode (negative) current collector also includes one or more carbon-containing layers formed on one or more surfaces of the anode current collector prior to an initial first charge cycle of the sodium-ion cell. Such layers can comprise amorphous carbon (e.g., a carbon black, such as TIMCAL Super C65), ideally having a thickness from about 10 Angstrom to about 1000 μm.

Alternatively, the anode (negative) current collector disclosed herein does not include one or more carbon-containing layers on one or more surfaces of the anode current collector prior to an initial first charge cycle of the sodium-ion cell. Therefore, the anode current collector is “pristine” prior to an initial first charge cycle of the sodium-ion cell. As used herein with respect to current collectors, the phrase “pristine” means that the current collector is in its “as made” state prior to an initial first charge cycle of the sodium-ion cell. In other words, the anode current collector is essentially the pure material from which it is formed from, barring impurities (e.g. surface oxide layers etc). As such the anode current collector is not coated with one or more carbon-containing layers (as discussed above), conventional active materials, binders, or the like.

A sodium-ion cell disclosed herein may also include a separator located between the cathode and the anode current collector. A polyolefin separator is preferable.

The anode (negative) electrode of the sodium-ion cell according to the present invention preferably further includes a polymeric binder. Typically, the polymeric binder is selected from polyvinylidene fluoride (PVDF), styrene-butadiene rubber (SBR), and carboxymethylcellulose (CMC). Preferably, the polymer binder comprises carboxymethylcellulose (CMC). Highly preferably, the polymer binder comprises a mixture of styrene-butadiene rubber (SBR) and carboxymethylcellulose (CMC).

The anode (negative) electrode of the sodium-ion cell according to the present invention ideally comprises a negative active material (A), one or more polymeric binders (B), and one or more conductive additives (C). Such a mixture is typically mixed with an aqueous or non-aqueous solvent (such as water or N-methyl Pyrrolidone (NMP)) and then disposed as a layer or film on one or more surfaces of an anode current collector via techniques such as doctor blade or slot die methods.

Typically, A:B:C are present in a weight ratio of from (80 to 98):(1 to 19):(1 to 19), and ideally in a weight ratio of from (90 to 98):(1 to 9):(1 to 9). When the polymer binder comprises polyvinylidene fluoride (PVDF), A:B:C are preferably in present in a weight ratio of about 88:9:3. When the polymer binder preferably comprises carboxymethylcellulose (CMC), and highly preferably comprises a mixture of styrene-butadiene rubber (SBR) and carboxymethylcellulose (CMC), A:B:C are preferably in a weight ratio of about 95:3.5:1.5.

The one or more conductive additives (C) may include one or more of carbon black, carbon nanotubes, graphene, acetylene black, and carbon nanofiber. Preferably, the one or more conductive additives includes carbon black, such as TIMCAL Super C65.

The anode (negative) electrode of the sodium-ion cell according to the present invention preferably further includes a negative active material. For example, the negative electrode which comprises a negative active material may be one or more of graphite material, soft carbon, hard carbon, carbon fibers, mesocarbon microbeads, silicon-based material, tin-based material, P-based material, Sb-based material, SnSb-based material, other types of materials that store charge via a conversion and/or alloying-type reaction (such as simple/binary/ternary etc oxides of Fe, Cu, Ni, Mn etc) and materials that store charge via a classical intercalation-type reaction such as lithium titanium oxide, different types of sodium titanates, titania etc; along with any combination of one or more of these preceding materials such as carbon/Sb, carbon/P, carbon/Fe₂O₃, either as mixtures generated by physical blends (such as carbon and Sb blended together by physical or chemical mixing methods such as ball-milling or spray-drying) or via an in-situ reaction (via an appropriate synthesis route such as solvo/hydrothermal, sol-gel, solution-based, reflux, co-precipitation, or solid-state reaction with or without subsequent heating/pyrolysis steps), the latter of which might result also result in doped materials (such as doped carbon with Sb or P or Sn) and/or substituted materials (such as substitution of Fe₂O₃ with a bit of TiO₂). The anode electrode of the sodium-ion cell according to the present invention preferably includes a negative active material that comprises hard carbon.

The electrolyte compositions of the present invention will be especially useful in sodium-ion cells which employ an anode electrode which includes a negative active material that comprises a non-graphitic carbon-containing material such as a hard carbon, or an anode which comprises a sodium insertion material, or a conversion and/or alloying anode material.

The cathode (positive) electrode of the sodium-ion cell according to the present invention preferably further includes a polymeric binder. Typically, the polymeric binder is selected from polyvinylidene fluoride (PVDF), styrene-butadiene rubber (SBR), and carboxymethylcellulose (CMC). Preferably, the polymer binder comprises polyvinylidene fluoride (PVDF).

The cathode (positive) electrode of the sodium-ion cell according to the present invention ideally comprises a positive active material (A), one or more polymeric binders (B), and one or more conductive additives (C). Such a mixture is typically mixed with an aqueous or non-aqueous solvent (such as water or N-methyl Pyrrolidone (NMP)) and then disposed as a layer or film on one or more surfaces of an anode current collector via techniques such as doctor blade or slot die methods.

Typically, A:B:C are present in a weight ratio of from (80 to 98):(1 to 19):(1 to 19). When the polymer binder comprises polyvinylidene fluoride (PVDF), A:B:C are preferably in present in a weight ratio of about 89:5:6, or alternatively, 92:4:4.

The one or more conductive additives (C) may include one or more of carbon black, carbon nanotubes, graphene, acetylene black, and carbon nanofiber. Preferably, the one or more conductive additives includes carbon black, such as TIMCAL Super C65.

The cathode (positive) electrode of the sodium-ion cell according to the present invention preferably further includes a sodium-containing positive active material which is adapted to allow the insertion/removal of sodium ions during charge/discharge. Examples of these include sodium transition metal oxides, polyanionic compounds (including fluorinated polyanionic compounds), Prussian blue analogue (PBA) compounds (such as Prussian White or Berlin Green), materials storing sodium via a conversion reaction, sodium transition metal fluorides, oxyfluorides, phosphates, sulfates, and silicates (and their fluorinated versions). Preferred examples are sodium transition metal oxides.

Preferred sodium transition metal oxides are of the general formula:

A_{1±δ}M¹_{V}M²_{W}M³_{X}M⁴_{Y}M⁵_{Z}O_{2-c}

wherein
A is one or more alkali metals selected from sodium, potassium and lithium;
M¹ comprises one or more redox active metals in oxidation state +2, preferably selected from the group consisting of nickel, copper, cobalt and manganese;
M² comprises a metal in oxidation state greater than 0 to less than or equal to +4;
M³ comprises a metal in oxidation state +2;
M⁴ comprises a metal in oxidation state greater than 0 to less than or equal to +4;
M⁵ comprises a metal in oxidation state +3;
wherein
0≤δ≤1;
V is >0;
W is ≥0;
X is ≥0;
Y is ≥0;
at least one of W and Y is >0
Z is ≥0;
C is in the range 0≤c<2
wherein V, W, X, Y, Z and C are chosen to maintain electrochemical neutrality.

Ideally, metal M² comprises one or more transition metals, and is preferably selected from manganese, titanium and zirconium; M³ is preferably one or more selected from magnesium, calcium, copper, tin, zinc and cobalt; M⁴ comprises one or more transition metals, preferably selected from manganese, titanium and zirconium; and M⁵ is preferably one or more selected from aluminium, iron, cobalt, tin, molybdenum, chromium, vanadium, scandium and yttrium.

A particularly preferred positive electrode active material for use in a sodium-ion cell will be a nickelate-based material. A sodium-containing active material with any crystalline structure may be used, however, preferably the structure will be O3 or P2 or a derivative thereof, but, specifically, it is also possible that the cathode electrode active material will comprise a mixture of phases, i.e. it will have a non-uniform structure composed of several different crystalline forms. For example, the cathode active material will comprise a compound with the general formula detailed above in a mixture of O3 and P2 phases. The ratio of O3:P2 phases is preferably 1 to 99:99 to 1.

The present invention also provides in another aspect the use of a non-aqueous electrolyte composition as defined herein in a sodium-ion cell.

The sodium-ion cells of the present invention may be used in an energy storage device, for example a battery, a rechargeable battery, an electrochemical device and an electrochromic device.

The present invention also provides in another aspect an apparatus comprising one or more sodium-ion cells as disclosed herein. A typical apparatus may include a device such as a battery pack that may have use in either a stationary or a mobile application.

The present invention also provides in another aspect a method of manufacturing a non-aqueous electrolyte composition as defined herein.

In an alternative aspect, there is provided a non-aqueous electrolyte composition comprising: a) one or more sodium-containing salts; and b) a solvent system which comprises i) a first component which comprises one or more organo carbonate-based solvents; and ii) a second component which comprises one or more performance additives that includes tris(trimethylsilyl) borate (TMSB) in an amount of >0 to ≤10% by weight of the solvent system, optionally in which the non-aqueous electrolyte composition does not include 1,1,2,2-Tetrafluoroethyl-2,2,3,3-tetrafluoropropyl ether (HFE) in amount of 20% by weight of the solvent system.

In further alternative aspects, there is provided a sodium-ion cell, preferably a sodium-ion full cells (not a sodium-metal half-cell) which comprises a non-aqueous electrolyte composition according to the alternative aspect described above.

### BRIEF DESCRIPTION OF THE DRAWINGS

The present invention will now be described with reference to the following figures in which:

FIG. 1 shows a plot of discharge energy retention (%) vs cycle number to illustrate the long-term cycling stability of a cell that used an electrolyte composition of the present invention (sample TEL 24d), compared against the cycling performance of a cell which uses a control electrolyte composition (sample TEL 24b).

FIG. 2A shows a plot of discharge energy retention (%) vs cycle number to illustrate the long-term cycling stability of a cell that used an electrolyte composition of the present invention (sample TEL 67a), compared against the cycling performance of a cell which uses a control electrolyte composition (sample TEL 67).

FIG. 2B shows the plot of FIG. 2A but with a different (enlarged) scale on the y-axis (discharge energy retention (%)).

FIG. 3A shows a plot of discharge energy retention (%) vs cycle number to illustrate the long-term cycling stability of a cell that used an electrolyte composition of the present invention (sample TEL 67a), compared against the cycling performance of a cell which uses a control electrolyte composition (sample TEL 67).

FIG. 3B shows the plot of FIG. 3A but with a different (enlarged) scale on the y-axis (discharge energy retention (%)).

FIG. 4 shows a plot of discharge capacity retention (%) vs cycle number to illustrate the long-term cycling stability of a cell that used an electrolyte composition of the present invention (sample TEL 67a), compared against the cycling performance of a cell which uses a control electrolyte composition (sample TEL 67).

FIG. 5 shows a plot of cathode discharge capacity (mAh/g) vs cycle number to illustrate the long-term cycling stability of a cell that used an electrolyte composition of the present invention that contained a mixture of sodium-containing salts (samples TEL 87b and TEL 90) compared against the cycling performance of a cell which used an electrolyte composition of the present invention that contained only one type of sodium-containing salt (sample TEL 67a).

FIG. 6 shows a plot of voltage (V) vs state of charge (SOC) or depth of discharge (DOD) to illustrate the reduced total charging time of a cell that used an electrolyte composition of the present invention that contained a mixture of sodium-containing salts (samples TEL 87b and TEL 90) compared against a cell which used an electrolyte composition of the present invention that contained only one type of sodium-containing salt (sample TEL 67a).

### EXAMPLES

The electrolyte compositions under investigation were prepared using the following general procedure: appropriate amounts of a first component (e.g., solvents for the desired solvent system) and then the second component (e.g., the correct amount of one or more performance additives) were weighted out in an argon-filled glove box and added to a brown or clear glass bottle.

To dry the formed solvent thoroughly, 4 Å molecular sieves (Sigma-Aldrich) were added and allowed to dry the solvent mixture for at least 24 h. The solvent system was then ready to be used and stored in the argon-filled glovebox. The appropriate amount of metal-containing salt(s) was then added to another bottle (either a clear or brown glass bottle or a container made from alternate materials such as polypropylene, PTFE, stainless steel etc), to which the required quantity of the solvent-mixture was added.

The electrolyte was then stirred either via a magnetic pellet or a mechanical stirrer for any duration between 5 min-100 h, or alternatively, the salt(s) was allowed to naturally dissolve in the electrolyte by simply letting the bottle/container stand undisturbed or in an accelerated fashion by mechanically shaking the bottle/container.

The precise composition of each of the electrolyte compositions investigated, is detailed in Table 1 below:

TABLE 1

| Electrolyte | |
|---|---|
| Composition Sample | |
| Ref. | Composition |
| TEL 24b (not | 1 m NaPF₆ in EC:DEC:PC = 1:2:1 wt/wt with 1 wt % PCS and 1 |
| according to the | wt % P123. |
| present invention) | |
| TEL 24d | 1 m NaPF₆ in EC:DEC:PC = 1:2:1 wt/wt with 1 wt % PCS, 1 wt % |
| | P123 and 1 wt % TMSB |
| TEL 67 (not according | 1 m NaPF₆ in PC: with 20 wt % DEC, 2 wt % PCS and 1 wt % P123 |
| to the present | |
| invention) | |
| TEL 67a | 1 m NaPF₆ in PC with 20 wt % DEC, 2 wt % PCS, 1 wt % TMSB, |
| | 1 wt % P123 |
| TEL 87b | 1 m NaPF₆ + 0.5 m NaTFSI in PC with 40 wt % DEC, 2 wt % PCS, |
| | 1 wt % P123 and 1 wt % TMSB |
| TEL 90 | 1 m NaPF₆ + 0.5 m NaFSI in PC with 40 wt % DEC, 2 wt % PCS, |
| | 1 wt % P123 and 1 wt % TMSB |

For the avoidance of doubt, concentrations expressed by “m” (molality) above relate to the total number of moles of the metal-containing salts, per 1 kg or 1000 g of the solvent system.

### Abbreviations Used:

EC=Ethylene carbonate, DEC=Diethyl carbonate, PC=Propylene carbonate, PCS=1,3-propanediolcyclic sulfate, P123=Poloxamer (Pluronic) P123, TMSB=Tris(trimethylsilyl) borate, NaTFSI I=Sodium bis(trifluoromethylsulfonyl)imide NaFSI=Sodium bis(fluorosulfonyl)imide

Please note that in the above Table 1, the wt % of the various solvents and/or performance additives are mentioned with respect to the total solvent system weight (they do not account for the weight(s) of the one or more sodium containing salts).

### Cell Construction

### General Procedure to Make a Hard Carbon Na-Ion Cell

Sodium-ion cells were fabricated using a mixed phase O3/P2 oxide cathode, hard carbon anode, and electrolyte (as appropriate). Aluminium tabs were connected to each of the electrodes and the cell was encased in a polymer-coated aluminium pouch.

The positive (cathode) electrode was prepared by solvent-casting a slurry of the active material, conductive carbon, binder and solvent using the doctor blade method. The conductive carbon used was C65 (Imerys). PVdF co-polymer (e.g. W #7500 from Kureha Chemicals) was used as the binder, and N-methyl Pyrrolidone (NMP) was employed as the solvent. The slurry was then cast onto carbon-coated aluminium foil and dried at about 120° C. under vacuum. The electrode film contained the following components, expressed in percent by weight, for cells FPC200725, FPC200818, FPC200728, FPC200729: 89% active material, 5% C65 carbon, and 6% W #7500 binder. Alternatively, all other cells used the following electrode formulation in the cathode: 92% active material, 4% C65 carbon and 4% PVdF binder.

The hard carbon negative (anode) electrode was prepared by solvent-casting a slurry of the hard carbon active material (Kuranode Type 1, supplied by Kureha), conductive carbon, binder and solvent, by the doctor blade method. The conductive carbon used was C65 (Imerys). A mixture of sodium carboxymethylcellulose (CMC) (Aqualon™ AQU D-5283 from Ashland) and styrene-butadiene rubber (SBR) (BM-451B from Zeon Europe Gmbh) was used as the binder, and water was employed as the solvent. The slurry was then cast onto carbon-coated aluminium foil and dried at about 120° C. under vacuum. The electrode film contained the following components, expressed in percent by weight, for cells FPC200725, FPC200818, FPC200728, FPC200729: 88% active material, 3% C65 carbon and 9% PVdF binder. Alternatively, all other cells used the following electrode formulation in the anode: 95% active material, 1.5% C65 carbon, and 3.5% CMC-SBR binder mixture.

After coating the cathode and anode, they were stamped at the desired dimensions. The coating weights of the cathode and anode have been mentioned as a GSM value (grams per square metres). ‘C/A’ refers to the mass ratio of the cathode active to the anode active materials in the respective coatings.

The separator used was a typical polyolefinic separator used commonly for any type of rechargeable lithium-ion or sodium-ion battery, such as Celgard 2500. The cathode/separator/anode assembly was placed within a pouch with two Al-based connecting tabs serving as the terminals, inside the glove box, and filled with the stated liquid electrolytes in quantities typical of such types of polyolefinic separator-containing lithium-ion or sodium-ion cells. These pouch cells were then sealed in the glove box and brought out for cell testing.

### Cell Testing

The cells were tested using Constant Current (Galvanostatic) Cycling techniques. Generally speaking, the cells were first charged via the constant current (CC) mode to a pre-defined maximum voltage limit. Afterwards, the cell was made to undergo a constant voltage (CV) step at that maximum voltage limit, to either a pre-defined time or this CV step was made to last until the current dropped to a pre-defined value, as indicated in the examples. In some examples, the cells were made to undergo a series of different CC-modes to different voltage values, before undergoing the CV step only at the maximum voltage value. The discharge process was either conducted at CC-mode to the lower cut-off voltage, or in constant power (CP) mode, as indicated.

A commercial battery cycler from MTI Inc. (Richmond, CA, USA) or Maccor (Tulsa, OK, USA) was used. On charge, alkali ions are inserted into the carbon-containing anode material. During discharge, alkali ions are extracted from the and re-inserted into the cathode active material.

All cells were subject to cycling experiments at a charge rates such as ±1C (this can also be stated as ±C/1), ±C/5 or ±C/10 (or other rates, such as ±C/50, as mentioned for each experiment). Rate performance tests saw discharge rates of C/5, C/10, 1C and 2C also. All cells were rested for at least 4-24 h prior to cycling. Table 2 provides a summary of the conditions of each experiment. In some embodiments, the cells were charged according to a dynamic protocol, which has been mentioned in the specific examples.

TABLE 2
Summary of Cycling Experiments

| | | | | Electrolyte | | |
|---|---|---|---|---|---|---|
| Experiment No. | Experiment type | Sample No. | Cell type | No. | Electrolyte composition | C/A |
| 1A (not according to the | EC:DEC:PC Solvent | FPC200725 | 100 mAh | TEL 24b | 1 m NaPF6 in EC:DEC: PC = 1:2:1 | 2.72 |
| present invention) | System | | Pouch Cell | | wt/wt with 1 wt % PCS and 1 wt % | |
| | | | | | P123. | |
| 1B | EC:DEC:PC Solvent | FPC200818 | 100 mAh | TEL 24d | 1 m NaPF6 in EC:DEC:PC = 1:2:1 | 2.78 |
| | System | | Pouch Cell | | wt/wt with 1 wt % PCS, 1 wt % P123 | |
| | | | | | and 1 wt % TMSB. | |
| 2A (not according to the | PC-dominant with 61 | FPC200728 | 100 mAh | TEL 67 | 1 m NaPF6 in PC with 20 wt % DEC, | 2.74 |
| present invention) | GSM Anodes | | Pouch Cell | | 2 wt % PCS and 1 wt % P123 | |
| 2B | PC-dominant with 61 | FPC200729 | 100 mAh | TEL 67a | 1 m NaPF6 in PC with 20 wt % DEC, | 2.79 |
| | GSM Anodes | | Pouch Cell | | 2 wt % PCS, 1 wt % P123 and 1 wt % | |
| | | | | | TMSB | |
| 3A (not according to the | PC-dominant with | FPC220205 | 150 mAh | TEL 67 | 1 m NaPF6 in PC with 20 wt % DEC, | 1.53 |
| present invention) | 121 GSM Anodes | | Pouch Cell | | 2 wt % PCS and 1 wt % P123 | |
| 3B (not according to the | PC-dominant with | FPC220206 | 150 mAh | TEL 67 | 1 m NaPF6 in PC with 20 wt % DEC, | 1.52 |
| present invention) | 121 GSM Anodes | | Pouch Cell | | 2 wt % PCS and 1 wt % P123 | |
| 3C | PC-dominant with | FPC211008 | 150 mAh | TEL 67a | 1 m NaPF6 in PC with 20 wt % DEC, | 1.61 |
| | 121 GSM Anodes | | Pouch Cell | | 2 wt % PCS, 1 wt % P123 and 1 wt % | |
| | | | | | TMSB | |
| 3D | PC-dominant with | FPC211009 | 150 mAh | TEL 67a | 1 m NaPF6 in PC with 20 wt % DEC, | 1.59 |
| | 121 GSM Anodes | | Pouch Cell | | 2 wt % PCS, 1 wt % P123 and 1 wt % | |
| | | | | | TMSB | |
| 3E | PC-dominant with | FPC211011 | 150 mAh | TEL 67a | 1 m NaPF6 in PC with 20 wt % DEC, | 1.61 |
| | 121 GSM Anodes | | Pouch Cell | | 2 wt % PCS, 1 wt % P123 and 1 wt % | |
| | | | | | TMSB | |
| 4A (not according to the | 32 Ah Cells | U016 | 32 Ah Pouch | TEL 67 | 1 m NaPF6 in PC with 20 wt % DEC, | 1.6 |
| present invention) | | | Cell | | 2 wt % PCS and 1 wt % P123 | |
| 4B (not according to the | 32 Ah Cells | U018 | 32 Ah Pouch | TEL 67 | 1 m NaPF6 in PC with 20 wt % DEC, | 1.6 |
| present invention) | | | Cell | | 2 wt % PCS and 1 wt % P123 | |
| 4C | 32 Ah Cells | U007 | 32 Ah Pouch | TEL 67a | 1 m NaPF6 in PC with 20 wt % DEC, | 1.6 |
| | | | Cell | | 2 wt % PCS, 1 wt % P123 and 1 wt % | |
| | | | | | TMSB | |
| 4D | 32 Ah Cells | U008 | 32 Ah Pouch | TEL 67a | 1 m NaPF6 in PC with 20 wt % DEC, | 1.6 |
| | | | Cell | | 2 wt % PCS, 1 wt % P123 and 1 wt % | |
| | | | | | TMSB | |
| 5A | Fast Charging | FPC220504 | 100 mAh | TEL 87b | 1 m NaPF6 + 0.5m NaTFSI, in PC | 2.21 |
| | | | Pouch Cell | | with 40 wt % DEC, 2 wt % PCS, 1 | |
| | | | | | wt % P123 and 1 wt % TMSB | |
| 5B | Fast Charging | FPC220505 | 100 mAh | TEL 90 | 1 m NaPF6 + 0.5m NaFSI, in PC with | 2.20 |
| | | | Pouch Cell | | 40 wt % DEC, 2 wt % PCS, 1 wt % | |
| | | | | | P123 and 1 wt % TMSB | |
| 5C | Fast Charging | FPC220710 | 100 mAh | TEL 67a | 1 m NaPF6 in PC with 20 wt % DEC, | 2.28 |
| | | | Pouch Cell | | 2 wt % PCS, 1 wt % P123 and 1 wt % | |
| | | | | | TMSB | |

Experiment 1—the Cycling Performance of Cells which Use an Electrolyte Composition that Contains EC:DEC:PC=1:2:1 wt/wt Solvent System, with or without TMSB Additive.

Experiment 1 compares the cycling performance of two identical Na-ion 100 mAh pouch cells (two cathode/anode electrode-pairs stacked in parallel within a single pouch cell), where the anode coat weight was 61 GSM (grams per square metre).

### Experiment 1A

Using the general method discussed above to prepare a hard carbon sodium-ion cell, electrolyte composition TEL 24b (not according to the present invention) was employed to prepare a test pouch cell (FPC200725). The cycling performance of the test cell was then investigated by cycling as follows:

FPC200725 was cycled between 4.05-1 V at +1C with a CV (constant voltage) step at 4.05 V lasting either 20 minutes, or stopping when the current reduced to a value equivalent to lower than C/10 (whichever occurred first). Thus, the longest time span that this cell experienced at 4.05 V was 20 minutes after each charging cycle.

### Experiment 1B

Using the general method discussed above to prepare a hard carbon sodium-ion cell, electrolyte composition TEL 24d (according to the present invention) was employed to prepare a test pouch cell (FPC200818). The cycling performance of the test cell was then investigated by cycling as follows:

FPC200818 was cycled between 4.05-1 V at +1C with a CV (constant voltage) step at 4.05 V lasting for one hour (60 minutes). Thus, the longest time span that this cell experienced at 4.05 V was 60 minutes after each charging cycle.

### Analysis

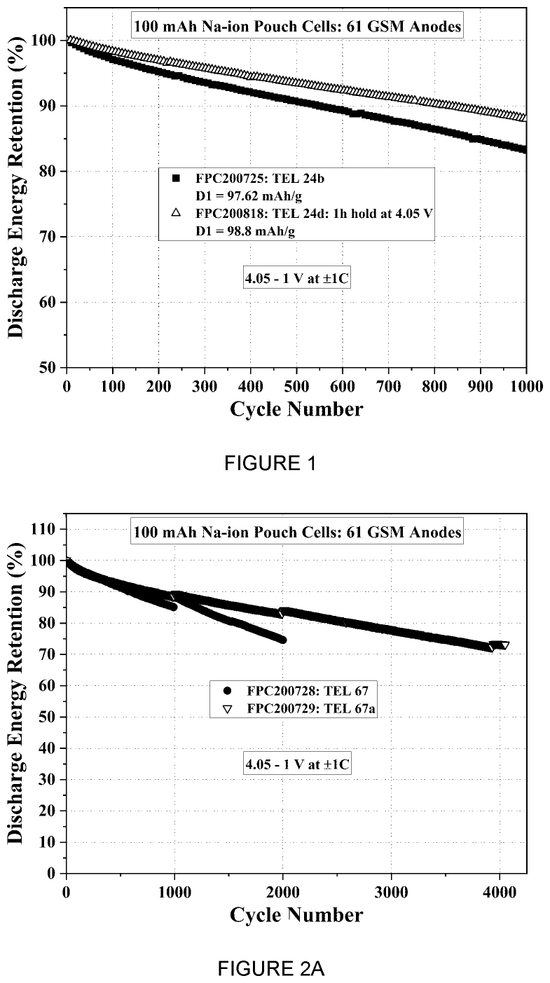

The cycling stability over 1000 cycles is shown in FIG. 1 which compares discharge energy retention vs cycle number for each of cell FPC200725 and FPC200818.

It can be seen that cell FPC200725 that used a control electrolyte composition (sample TEL 24b) retained 83.2% of its initial energy after 1000 cycles. In contrast, cell FPC200818 that used an electrolyte composition of the present invention (sample TEL 24d) retained 88% of its initial delivered energy after 1000 cycles.

Furthermore, cell FPC200818 was also subject to more rigorous conditions than cell FPC200725 (i.e., high voltage conditions under which oxidation of electrolyte may occur). This is because cell FPC200818 was held at 4.05 V under CV conditions for 60 minutes after each charging cycle, compared to cell FPC200725 which was held at 4.05 V under CV conditions for 20 minutes after each charging cycle.

The skilled person understands that a longer CV step may result in greater cell capacity but at a cost of lower energy retention. However, surprisingly, cell FPC200818 delivered improved energy retention after 1000 cycles, compared to cell FPC200725.

Specifically, cell FPC200818 delivered a capacity of 98.82 mAh/g on the first cycle, and a capacity of 92.19 mAh/g after 1000 cycles (thus, a 93.3% capacity retention over 1000 cycles). This equates to a discharge energy retention of 88% as shown by FIG. 1.

In contrast, cell FPC200725 delivered a capacity of 97.62 mAh/g on the first cycle, and a capacity of 87.18 mAh/g after 1000 cycles (thus, a 89.3% capacity retention over 1000 cycles). This equates to a discharge energy retention of 83.2% as shown by FIG. 1.

Thus, cycling performance in terms of stability and discharge capacity (as well as energy retention) is improved in a sodium-ion cell by using an electrolyte composition according to the present invention.

Experiment 2—the Cycling Performance of Cells Using 61 GSM Coat Weight Anodes which Use an Electrolyte Composition that Contains PC-Dominant Carbonate-Ester Solvent System with or without TMSB Additive.

Experiment 2 used the same type of Na-ion pouch cells as was used in Experiment 1 (100 mAh pouch cells with 61 GSM coat weight hard carbon anodes with a similar C/A), with a similar cycling protocol, as indicated below:

### Experiment 2A

Using the general method discussed above to prepare a hard carbon anode and O3/P2 layered oxide cathode sodium-ion cell, electrolyte composition TEL 67 (not according to the present invention) was employed to prepare a test pouch cell (FPC200728). The cycling performance of the test cell was then investigated by cycling as follows: FPC200728 was cycled between 4.05-1 V at +1C.

### Experiment 2B

Using the general method discussed above to prepare a hard carbon anode and O3/P2 layered oxide cathode sodium-ion cell, electrolyte composition TEL 67a (according to the present invention) was employed to prepare a test pouch cell (FPC200729). The cycling performance of the test cell was then investigated by cycling as follows: FPC200729 was cycled between 4.05-1 V at +1C.

### Analysis

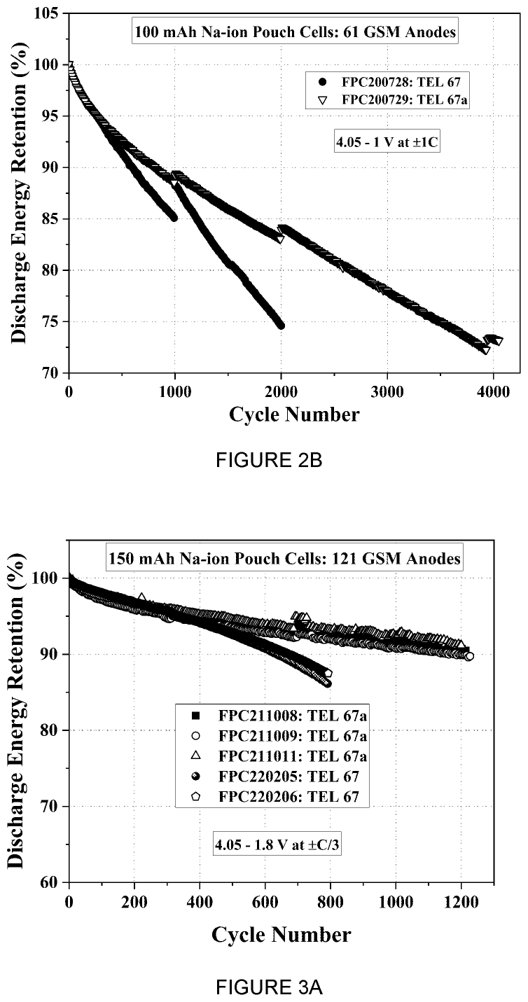

The cycling stability is shown in FIGS. 2A and 2B which shows the discharge energy retention of cell FPC200728 over 2000 cycles compared with the discharge energy retention of cell FPC200729 over 4050 cycles.

It can be seen that cell FPC200728 that used a control electrolyte composition (sample TEL 67) retained 74.6% of its initial energy after 2000 cycles. In contrast, cell FPC200729 that used an electrolyte composition of the present invention (sample TEL 67a) retained 73.1% of its initial delivered energy after 4050 cycles.

Specifically, cell FPC200728 delivered a capacity of 97.56 mAh/g on the first cycle, and a capacity of 78.12 mAh/g after 2000 cycles (thus, a capacity retention of 80% after 2000 cycles). This equates to a discharge energy retention of 74.6% as shown by FIGS. 2A and 2B.

In contrast, cell FPC200729 delivered a capacity of 98.37 mAh/g on the first cycle, and a capacity of 78.83 mAh/g after 4050 cycles (thus, a capacity retention of 80.13% after 4000 cycles). This equates to a discharge energy retention of 73.1% as shown by FIGS. 2A and 2B.

Thus, cycling performance in terms of stability and discharge capacity (as well as energy retention) is improved in a sodium-ion cell by using an electrolyte composition according to the present invention.

Experiment 3—the Cycling Performance of Cells Using 121 GSM Coat Weight Anodes which Use an Electrolyte Composition that Contains PC-Dominant Carbonate-Ester Solvent System with or without TMSB Additive.

Experiment 3 discusses results on 150 mAh Na-ion pouch cells using 121 GSM coatweight hard carbon anodes with a C/A around 1.5-1.6, cycled between 4.05-1.8 V at ±C/3, using either TEL 67 or TEL 67a (refer to Table 2).

### Experiment 3A & 3B

Using the general method discussed above to prepare a hard carbon anode and O3/P2 layered oxide cathode sodium-ion cell, electrolyte composition TEL 67 (not according to the present invention) was employed to prepare a test pouch cells FPC220205 and FPC220206. The cycling performance of the test cell was then investigated by cycling as follows:
FPC220205 and FPC220206 were cycled between 4.05-1.8 V at ±C/3.

### Experiment 3C, 3D & 3E

Using the general method discussed above to prepare a hard carbon anode and O3/P2 layered oxide cathode sodium-ion cell, electrolyte composition TEL 67a (according to the present invention) was employed to prepare a test pouch cells FPC211008, FPC211009, and FPC211011. The cycling performance of the test cell was then investigated by cycling as follows:
FPC211008, FPC211009, and FPC211011 were cycled between 4.05-1.8 V at +C/3.

### Analysis

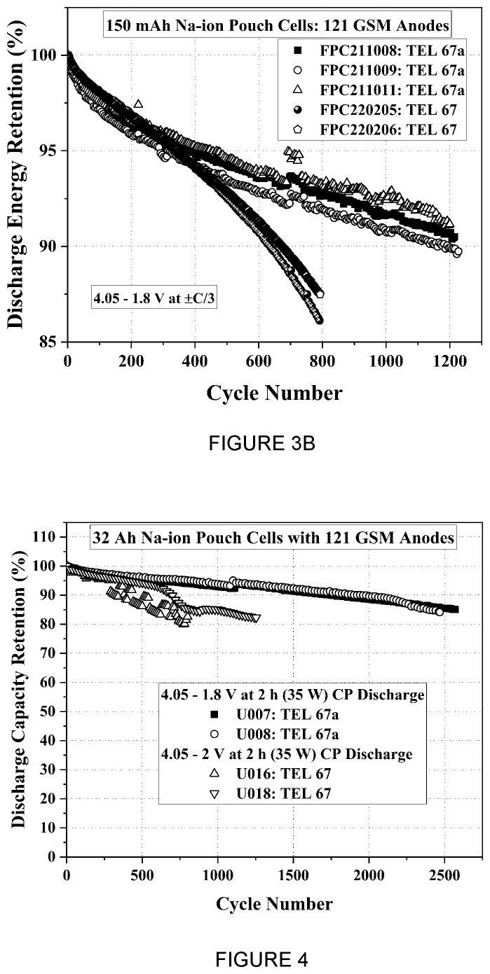

The cycling stability is shown in FIGS. 3A and 3B which shows the discharge energy retention of cell FPC220205 over 791 cycles and cell FPC220206 over 793 cycles, compared with the discharge energy retention of cell FPC211008 over 1214 cycles, cell FPC211009 over 1227 cycles, and cell FPC211011 over 1200 cycles.

It can be seen that when a control electrolyte composition (sample TEL 67) was used, cell FPC220205 had an 86.1% energy retention after 791 cycles, and cell FPC220206 had an 87.5% energy retention after 793 cycles.

In contrast, when an electrolyte composition of the present invention (sample TEL 67a) was used, cell FPC211008 had a 90.5% energy retention after 1214 cycles, cell FPC211009 had an 89.7% energy retention after 1227 cycles, and cell FPC211011 had a 91.2% energy retention after 1200 cycles.

Specifically:

FPC220205 delivered a capacity of 97.25 mAh/g on the first cycle, and a capacity of 86.4 mAh/g (thus, a capacity retention of 88.8%) after 791 cycles. This equates to a discharge energy retention of 86.1%.

FPC220206 delivered a capacity of 96.9 mAh/g on the first cycle, and a capacity of 87.39 mAh/g (thus, a capacity retention of 90.2%) after 793 cycles. This equates to a discharge energy retention of 87.5%.

FPC211008 delivered a capacity of 96.79 mAh/g on the first cycle, and a capacity of 89.33 mAh/g (thus, a capacity retention of 92.3%) after 1214 cycles. This equates to a discharge energy retention of 90.5%.

FPC211009 delivered a capacity of 96.28 mAh/g on the first cycle, and a capacity of 88.02 mAh/g (thus, a capacity retention of 91.4%) after 1227 cycles. This equates to a discharge energy retention of 89.7%.

FPC211011 delivered a capacity of 96.89 mAh/g on the first cycle, and a capacity of 90.05 mAh/g (thus, a capacity retention of 92.94%) after 1200 cycles. This equates to a discharge energy retention of 91.2%.

Thus, cycling performance in terms of stability and discharge capacity retention (as well as energy retention) is improved in a sodium-ion cell by using an electrolyte composition according to the present invention.

Experiment 4—the Cycling Performance of 32 Ah Na-Ion Pouch Cell Using 121 GSM Coat Weight Anodes which Use an Electrolyte Composition that Contains PC-Dominant Carbonate-Ester Solvent System with or without TMSB Additive.

Experiment 4 discusses results on 32 Ah Na-ion pouch cells using 121 GSM coatweight hard carbon anodes with a C/A around 1.6, cycled as follows, using either TEL 67 or TEL 67a (refer to Table 2).

### Experiment 4A & 4B

Using the general method discussed above to prepare a hard carbon anode and O3/P2 layered oxide cathode sodium-ion cell, electrolyte composition TEL 67 (not according to the present invention) was employed to prepare a test pouch cells U016 and U018. The cycling performance of the test cell was then investigated by cycling as follows:

U016 and U018 were cycled between 4.05-2 V with a CC charge and CV at 4.05 V, followed by 35 W CP discharge (equivalent to a ˜2 h discharge).

### Experiment 4C & 4D

Using the general method discussed above to prepare a hard carbon anode and O3/P2 layered oxide cathode sodium-ion cell, electrolyte composition TEL 67a (according to the present invention) was employed to prepare a test pouch cells U007 and U008. The cycling performance of the test cell was then investigated by cycling as follows:

U007 and U008 were cycled between 4.05-1.8 V with a CC charge and CV at 4.05 V, followed by 35 W CP discharge (equivalent to a ˜2 h discharge).

### Analysis

The cycling stability is shown in FIG. 4 which shows the discharge capacity retention of cell U016 over 800 cycles and cell U018 over 1254 cycles, compared with the discharge capacity retention of cell U007 over 2570 cycles and cell U008 over 2468 cycles.

It can be seen that when a control electrolyte composition (sample TEL 67) was used, cell U016 had an 82.6% capacity retention after 800 cycles, and cell U018 had an 82.3% capacity retention after 1254 cycles.

In contrast, when an electrolyte composition of the present invention (sample TEL 67a) was used, cell U007 had a 85% capacity retention after 2570 cycles, and cell U008 had an 84.1% after 2468 cycles.

Specifically:

U016 delivered a capacity of 86.09 mAh/g on the first cycle, and a capacity of 71.1 mAh/g (thus, a capacity retention of 82.6%) after 800 cycles.

U018 delivered a capacity of 88.66 mAh/g on the first cycle, and a capacity of 72.97 mAh/g (thus, a capacity retention of 82.3%) after 1254 cycles.

U007 delivered a capacity of 90.64 mAh/g on the first cycle, and a capacity of 77.09 mAh/g (thus, a capacity retention of 85%) after 2570 cycles

U008 delivered a capacity of 92.96 mAh/g on the first cycle, and a capacity of 78.21 mAh/g (thus, a capacity retention of 84.1%) after 2468 cycles.

Thus, cycling performance in terms of stability and discharge capacity retention is improved in a sodium-ion cell by using an electrolyte composition according to the present invention.

Experiment 5—the Cycling Performance of Na-Ion Cells which Use an Electrolyte Composition that Contains PC-Dominant Carbonate-Ester Solvent System with TMSB Additive and Investigate the Impact of Fast Charging.

Experiment 5 discusses results on 100 mAh Na-ion pouch cells, cycled between 4.15-1.8 V using different charging protocols, as indicated below, using either TEL 67a, TEL 87b or TEL 90 (refer to Table 2).

### Experiment 5A & 5B

Using the general method discussed above to prepare a hard carbon anode and O3/P2 layered oxide cathode sodium-ion cell, electrolyte composition TEL 87b (according to the present invention) was employed to prepare a test pouch cell FPC220504 and electrolyte composition TEL 90 (according to the present invention) was employed to prepare a test pouch cell FPC220505. The cycling performance of the test cells was then investigated by cycling as follows:
CC charging at +8C to 3.5 V, then +4C to 3.8 V, then +2C to 4 V and then +1C to 4.15 V.
CV charging at 4.15 V to C/10 or 5 min, whichever occurred first.
CC discharging to 1.8 V.

### Experiment 5C

Using the general method discussed above to prepare a hard carbon anode and O3/P2 layered oxide cathode sodium-ion cell, electrolyte composition TEL 67a (according to the present invention) was employed to prepare a test pouch cell FPC220710. The cycling performance of the test cell was then investigated by cycling as follows: the cell was cycled between 4.15-1.8 V at +1C with a CV step at 4.15 V (CV till C/10 or 10 min, whichever occurred first).

### Analysis

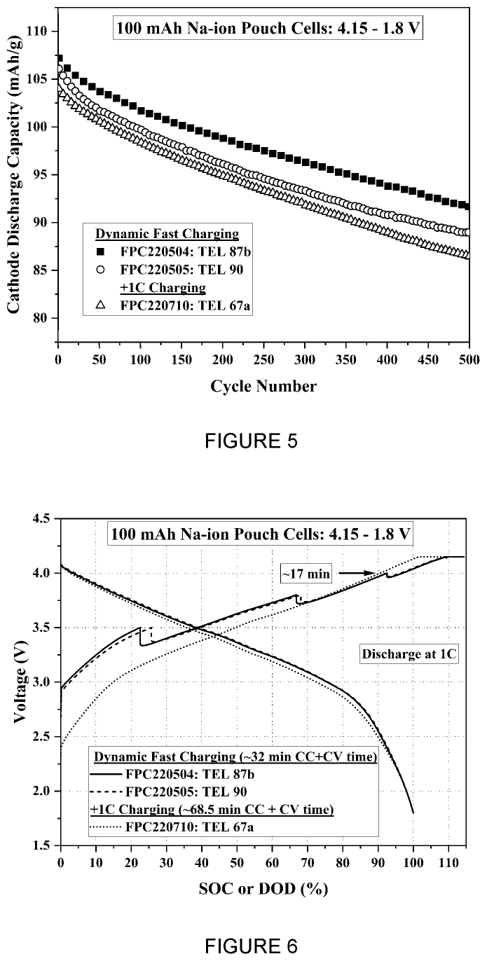

The cycling stability is shown in FIG. 5 which shows the cathode discharge capacity of the three cells over 500 cycles.

It can be seen that cells (FPC220504, FPC220505) cycled with an electrolyte composition of the present invention that contain a mixture of sodium-containing salts (sample TEL 87b and TEL 90, respectively) showed not only higher discharge capacities, but also better capacity retention, after 500 cycles, compared to a cell (FPC220710) cycled with an electrolyte composition of the present invention that contains only one type of sodium-containing salt (sample TEL 67a).

Specifically:

FPC220504 delivered a capacity of 107.2 mAh/g on the first cycle, and a capacity of 91.66 mAh/g (thus, a capacity retention of 85.5%) after 500 cycles. This equates to a discharge energy retention of 81%.

FPC220505 delivered a capacity of 106.1 mAh/g on the first cycle, and a capacity of 88.96 mAh/g (thus, a capacity retention of 83.8%) after 500 cycles. This equates to a discharge energy retention of 80.8%.

FPC220710 delivered a capacity of 103.98 mAh/g on the first cycle, and a capacity of 86.46 mAh/g (thus, a capacity retention of 83.15%) after 500 cycles. This equates to a discharge energy retention of 80.3%.

Thus, it can be clearly seen that the electrolyte compositions of the present invention are compatible with different types/mixtures of sodium-containing salts.

Furthermore, the better cycling stability and higher discharge capacities for the TEL 87b and TEL 90 cells were obtained whilst significantly reducing the total charging time. This has been shown in FIG. 6, which shows the cycling profiles of the cells during cycle 2. The x-axis is the state of charge (SOC) or depth of discharge (DOD): the skilled person will know that these metrics plot the normalised energy (vs the energy delivered at 1.8 V, which is 100% DOD for this particular experiment) vs the voltage of the cell. In FIG. 6, the total CC+CV charge time of the cells is also shown. From this Figure, it is clear that FPC220504 and FPC220505 not only result in higher initial discharge capacities and better capacity and energy retention after 500 cycles, but achieve this whilst reducing the total charge time by half:
The total charge time for FPC220504 using TEL 87b, at cycle 2, was 32.7 min.
The total charge time for FPC220505 using TEL 90, at cycle 2, was 31.8 min.
The total charge time for FPC220710 using TEL 67a, at cycle 2, was 68.5 min.

Furthermore, it can also be seen that FPC220504 and FPC220505 can be charged to ˜92.5% energy (SOC) within just 17 min. In contrast, FPC220710 could be charged to 92.5% SOC after ˜54 min. As will be appreciated, fast charging has tremendous industrial applicability as it reduces the time to charge a cell quickly.

From Experiment 5, it can be clearly seen that the electrolyte compositions of the present invention are compatible with different types/mixtures of sodium-containing salts, and also provide significantly reduced total charging times.

### CONCLUSIONS

From the above experiments, it is clear that the electrolyte compositions of the present invention comprising two or more organo carbonate-based solvents (i.e. mixtures) in combination with TMSB deliver, at the very least, longer cycle lives than their TMSB-free counterparts when cycled in a sodium ion cell. Significantly reduced total charging times in sodium-ion cells can also arise when the electrolyte compositions of the present invention further include two or more sodium-containing salts.

1-21. (canceled)

22. A non-aqueous electrolyte composition comprising:
a) one or more sodium-containing salts; and
b) a solvent system which comprises:
i. a first component which comprises a first organo carbonate-based solvent and a second organo carbonate-based solvent, in which the second organo carbonate-based solvent is different from the first organo carbonate-based solvent;
ii. a second component which comprises two or more performance additives that includes tris(trimethylsilyl) borate (TMSB) in an amount of >0 to ≤10% by weight of the solvent system and sulfur-containing compounds in an amount of >1 to ≤10% by weight of the solvent system; and
in which the first and second organo carbonate-based solvents are selected from ethylene carbonate (EC), diethyl carbonate (DEC), and propylene carbonate (PC).

23. The non-aqueous electrolyte composition according to claim 22, in which the first organo carbonate-based solvent comprises propylene carbonate and the second organo carbonate-based solvent is selected from ethylene carbonate (EC) and diethyl carbonate (DEC).

24. The non-aqueous electrolyte composition according to claim 22, in which the first organo carbonate-based solvent comprises propylene carbonate (PC) in an amount from >55% to <100% by weight of the solvent system, and the second organo carbonate-based solvent comprises diethyl carbonate (DEC) in an amount from >0 to <45% by weight of the solvent system.

25. The non-aqueous electrolyte composition according to claim 22, in which the first organo carbonate-based solvent comprises propylene carbonate (PC), and the second organo carbonate-based solvent comprises a mixture of ethylene carbonate (EC) and diethyl carbonate (DEC).

26. The non-aqueous electrolyte composition according to claim 22, in which the second component comprises three or more performance additives including tris(trimethylsilyl) borate (TMSB) in an amount of 1% by weight of the solvent system, sulfur-containing compounds in an amount of 2% by weight of the solvent system, and surfactants in an amount of 1% by weight of the solvent system.

27. The non-aqueous electrolyte composition according to claim 22, in which the second component further comprises one or more surfactants in an amount of >0.2 to ≤10% by weight of the solvent system.

28. The non-aqueous electrolyte composition according to claim 27, in which the surfactants include at least one non-ionic block copolymer surfactant.

29. The non-aqueous electrolyte composition according to claim 22, in which the sulfur-containing compounds include 1,3-propanediolcyclic sulfate (PCS).

30. The non-aqueous electrolyte composition according to claim 22, in which the one or more sodium-containing salts are selected from sodium hexafluorophosphate (NaPF₆), sodium bis(fluorosulfonyl)imide (NaFSI), and sodium bis(trifluoromethanesulfonyl) imide (NaTFSI).

31. The non-aqueous electrolyte composition according to claim 30, in which the one or more sodium-containing salts include sodium hexafluorophosphate (NaPF₆).

32. The non-aqueous electrolyte composition according to claim 22, further comprising two or more sodium-containing salts.

33. The non-aqueous electrolyte composition according to claim 32, in which the two or more sodium-containing salts include a mixture of sodium hexafluorophosphate (NaPF₆) in combination with sodium bis(fluorosulfonyl) imide (NaFSI) and/or sodium bis(trifluoromethanesulfonyl) imide (NaTFSI).

34. A non-aqueous electrolyte composition comprising:
a) two or more sodium-containing salts; and
b) a solvent system comprising:
i. a first component comprising a first organo carbonate-based solvent and a second organo carbonate-based solvent, in which the second organo carbonate-based solvent is different from the first organo carbonate-based solvent; and
ii. a second component comprising one or more performance additives that includes tris(trimethylsilyl) borate (TMSB) in an amount of >0 to ≤10% by weight of the solvent system.

35. A sodium-ion cell comprising a non-aqueous electrolyte composition according to claim 22.

36. A method of using a non-aqueous electrolyte composition in a sodium-ion cell, comprising operating the sodium-ion cell with the non-aqueous electrolyte composition according to claim 22.

37. An apparatus comprising the sodium-ion cell according to claim 35.

38. The non-aqueous electrolyte composition according to claim 28, wherein at least one non-ionic block copolymer surfactant comprises one or more poloxamers.

39. The non-aqueous electrolyte composition according to claim 26, in which the surfactant include at least one non-ionic block copolymer surfactant.

40. A sodium-ion cell comprising a non-aqueous electrolyte composition according to claim 34.

41. A method of using a non-aqueous electrolyte composition in a sodium-ion cell, comprising operating the sodium-ion cell with the non-aqueous electrolyte composition according to claim 34.
